(19) United States
(12) Patent Application Publication
(10) Pub. No.: US 2005/0093965 A1
(43) Pub. Date: May 5, 2005

(54) Multichannel printhead for photosensitive media

(75) Inventors: Badhri Narayan, Rochester, NY (US); Michael E. Harrigan, Victor, NY (US); Rongguang Liang, Penfield, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/700,832

(22) Filed: Nov. 4, 2003

(51) Int. Cl. B41J 2/45

(52) U.S. Cl. 347/238

(57) ABSTRACT

A printhead (10) forms an image onto a photosensitive medium (22) by exposing pixels in a succession of exposures. The printhead (10) has a housing with a first position for an illumination array (20) of LED emitters (16), a second position for a lens array of lens elements (28) and a light-guiding array (26) of uniformizer elements (34), arranged within a corresponding array of cavities extended between the first and second positions (32, 46). For each pixel exposed on the photosensitive medium (22), a single LED light emitter (16) in the illumination array (20) provides light into a single corresponding uniformizer element (34) in the light-guiding array (26), which directs light to a single corresponding lens assembly (38) of the lens array (28).

### FIELD OF THE INVENTION

This invention generally relates to printing apparatus and more particularly relates to a printhead having multiple channels using light emitting diode light sources.

### BACKGROUND OF THE INVENTION

Light emitting diode (LED) light sources offer a range of advantages over conventional types of illumination for printing apparatus. Among salient advantages of LEDs are low energy requirements, long life, relatively low cost, component durability and resistance to shock and vibration, and very good color performance and power output levels. LED arrays provide a compact packaging arrangement that makes these light sources particularly attractive for use in high-resolution printing applications.

LED arrays have been widely used in electrophotographic printing. For example, a typical non-contact LED array image printer is disclosed in U.S. Pat. No. 4,837,589, which discloses an LED array mounted on a substrate bearing an interface control circuit that receives image data through a ribbon cable. The LED array is imaged by a lens onto an exposure plane on a platen parallel to the direction of scanning. A photosensitive medium is driven in registration in forward and reverse directions biased against the exposure platen which defines the exposure plane. Other examples in which an LED array is used within a scanned printing arrangement include U.S. Pat. No. 4,837,587, which discloses a printing apparatus that employs a bank of LEDs and commonly-assigned U.S. Pat. No. 6,163,332.

LED arrays have been used to provide exposure energy applied to an intermediate drum or platen in some types of toner-based electrophotographic systems. Typical electrophotographic system designs employing an LED array use selfoc lenses or other lens array structures to provide 1:1 imaging, with minimal distance between the LED source and the imaged medium. Efficient capture of the LED light energy is not important with these devices; in general, only a portion of the light emitted from the LED array is needed for electrophotographic imaging.

However, although LED arrays have provided suitable exposure energy for toner-based electrophotographic systems, output characteristics of the emitted LED light constrain these devices from use with photosensitive film media. Among the limited uses of LED arrays proposed for photofinishing is the printing of metadata characters on the edge of a piece of film outside the image area, as disclosed in U.S. Pat. No. 6,429,924.

Thus, although there are a number of features of LED arrays that make these components attractive for use in printing images onto photosensitive media, there are still significant barriers to the use of LED arrays in photofinishing and related imaging applications. LEDs behave as extended Lambertian sources, radiating light over a broad range of angles, making it difficult to effectively capture much of their radiated power. Using LED sources for high-resolution imaging applications with photosensitive film and other media requires optics having very high numerical aperture. Additional difficulty is presented by the spatial energy profile of the LED itself. Referring to FIG. 1a, there is shown a spatial energy profile curve 12 for a typical LED emitter. An ideal energy profile curve 14 for photographic quality printing is represented in phantom, with the smooth appearance shown. As is apparent, spatial energy profile curve 12 contains both high- energy density points, or “hot spots”, and nearby areas of very low energy density. The jagged, irregular exposure energy profile of spatial energy profile curve 12 is thus not well-suited to the characteristics of a photosensitive medium such as photographic film. Moreover, hot spot distribution can vary from one LED to the next.

A top view of the light-providing surface of the emissive area of a single LED emitter 16 in a typical configuration is shown in FIG. 1b. As is intuitively clear, the shape of the emissive area of LED emitter 16 is related to its spatial energy profile curve 12. A typical hot spot 18 is shown in phantom in the view of FIG. 1b.

In addition to Lambertian characteristics and irregular spatial energy profile, other practical problems have constrained the usability of LED arrays in printing to photosensitive media. For example, there are limits to the number of LED emitters 16 that can be packaged into an array for a single printhead. For a photofinishing application, for example, packaging requirements make it difficult to provide a printhead that is sized to provide a complete 8×10 or 14×17 inch print in a single exposure.

A major challenge in forming high-resolution images on photosensitive media is achieving precision placement of exposed dots or pixels. As is well known in the electronic imaging arts, imaging artifacts on a printed medium are most easily perceived when they occur within a certain range of spatial frequencies. Even a slight variation in distance between adjacent LED channels of a fraction of a percent of the correct spacing can result in banding or streaking, objectionable in a printed image. Therefore, a scanning optical printhead used for this purpose must be designed to within sub-micron tolerances in order to obtain acceptable levels of precision.

Thus, because of a variety of performance and packaging problems and because of the need for high precision dot or pixel placement, LED die arrays have been overlooked or dismissed as being unsuitable for high-resolution printing to photosensitive media. However, there is a long-felt need to develop low-cost printing apparatus that take advantage of the cost and efficiency of LED die arrays and the image quality capabilities of photosensitive media.

### SUMMARY OF THE INVENTION

It is an object of the present invention to provide a printhead using an LED die array and a printing apparatus using the printhead. With this object in mind, the present invention provides a multichannel printhead for forming an image onto a photosensitive medium by exposing pixels in a succession of exposures, the printhead comprising:
(a) an illumination array of LED light sources fitted into a housing at a first position;
(b) a lens array comprising a plurality of lenses fitted into the housing at a second position; and
(c) a light-guiding array of unifornizer elements, arranged within a corresponding array of cavities formed within the housing and extended between the first position and the second position;
wherein, for each pixel exposed on the photosensitive medium:
   a single LED light source in the illumination array provides light into a single corresponding uniformizer element in the light-guiding array which directs light to a corresponding lens of the lens array.

It is a feature of the present invention that it provides a printhead for scanning a photosensitive medium to expose an image thereon, the image formed as a series of scanned lines of pixels. The printhead of the present invention is designed to provide precision accuracy of dot placement, with LEDs, lenses, and uniformizers fabricated to very close tolerances.

It is an advantage of the present invention that it provides a low-cost printhead solution for exposure of photosensitive media.

It is a further advantage of the present invention that it adapts LED illumination to the characteristics needed for exposure of a photosensitive medium. The printhead of the present invention thereby takes advantage of the long life, relatively low cost, small size and low energy requirements of LED die array illumination.

It is yet a further advantage of the present invention that it provides a relatively low-cost lens array having a high numerical aperture for directing light energy from each LED die array onto a photosensitive medium.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1a is a graph showing typical spatial profile of illumination intensity from a miniature LED;

FIG. 1b is a plane top view of a single miniature LED, such as would generate light having the overall spatial profile of FIG. 1a;

FIG. 2 is a plane top view of a printhead according to the present invention;

FIG. 3 is a side view of a printhead according to the present invention;

FIG. 4 is an exploded, perspective view showing key assemblies of a printhead according to the present invention;

FIG. 5 is a plan view of an LED die array used in the printhead of the present invention;

FIG. 6 is a cutaway view of a uniformizer in the printhead of the present invention;

FIG. 7 is a ray diagram showing an arrangement of lenslets used in a preferred embodiment of the present invention;

FIG. 8 is a perspective view showing the arrangement of a printing apparatus using the printhead according to the present invention; and

FIG. 9 is a perspective view showing an alternate arrangement of a printing apparatus using the printhead according to the present invention.

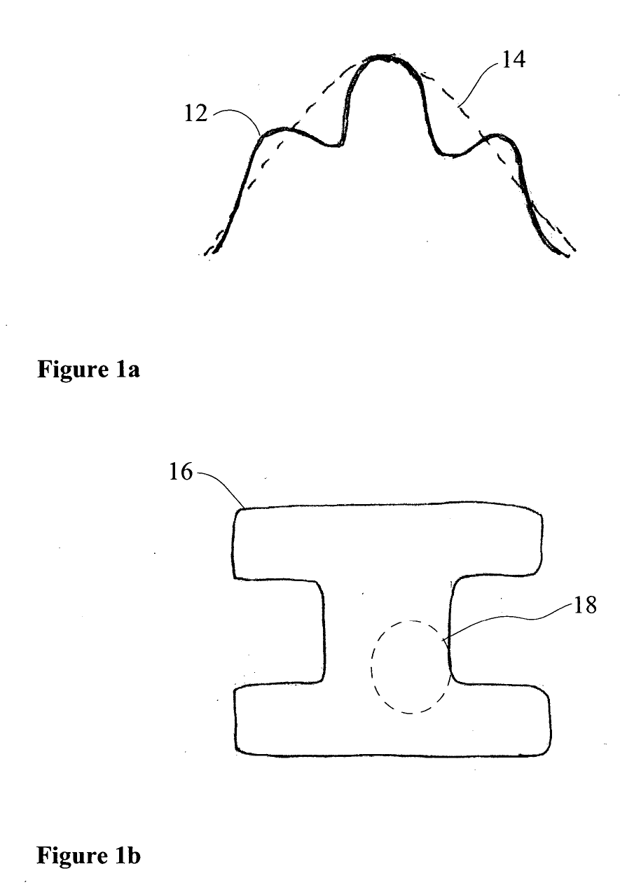

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

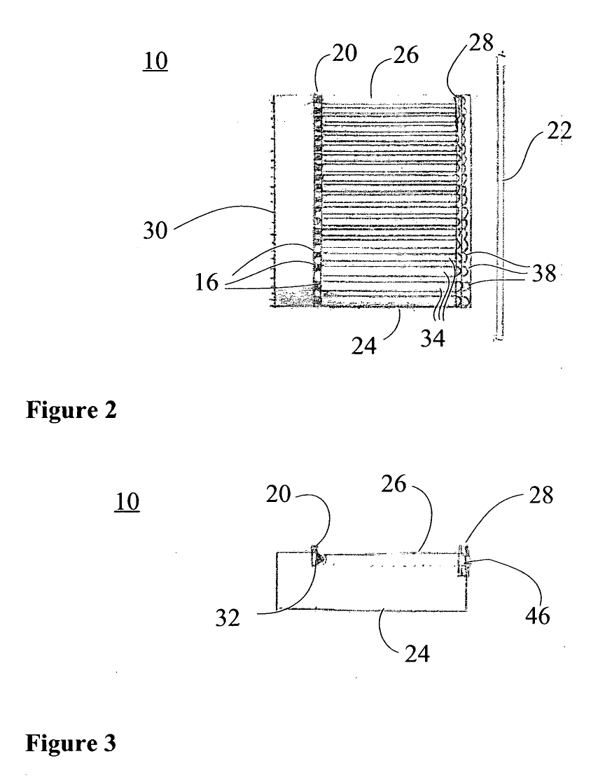

Referring to FIG. 2, there is shown a printhead 10 using an LED die array 20 for forming an image onto a photosensitive medium 22. Printhead 10 mounts, onto a single base 24, LED die array 20, a uniformizer array 26 and a lenslet array 28. A signal interface 30 routes the electronic signal for energizing each LED emitter 16 in LED die array 20. Connections to signal interface from driver circuitry (not shown) carry signals to energize individual LED emitters 16 in LED die array 20.

Referring to the side view of FIG. 3, there is shown the arrangement of LED die array 20, fitted into a slot 32, uniformizer array 26 (shown in phantom) formed as a series of grooves, and lenslet array 28 as fitted onto a seat 46 of base 24. This arrangement provides a single, robust package for printhead 10.

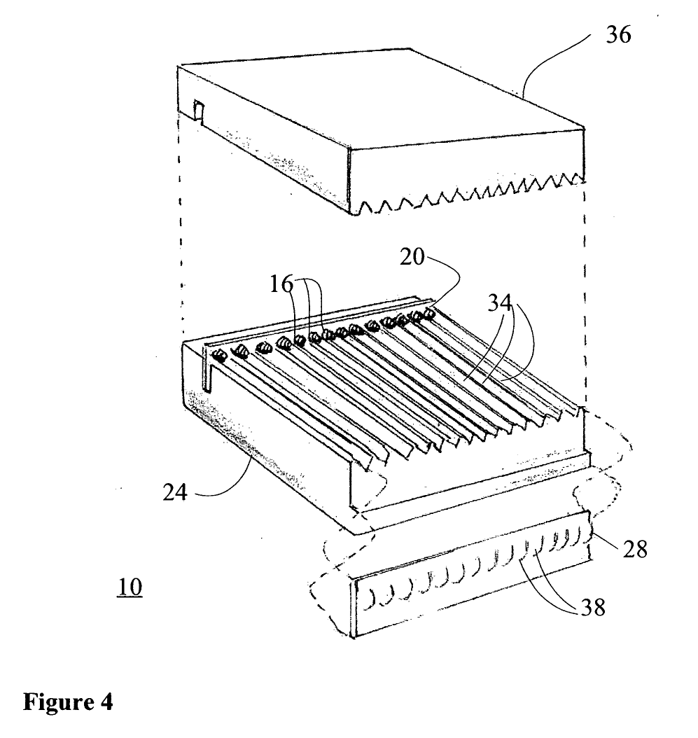

Referring to the exploded view of FIG. 4, there are shown key components of printhead 10. Each LED emitter 16 in LED die array 20 has a corresponding uniformizer 34 for uniformizing the light output of LED emitter 16 and providing this uniformized light to a lens assembly 38 in lenslet array 28. A cover 36 is provided to complete the assembly of printhead 10. Cover 36 is also used to form uniformizer array 26 as is described subsequently.

In a preferred embodiment, printhead 10 is fabricated on base 24 that is, in turn, fabricated using precision assembly techniques, such as Silicon Optical Bench (SiOB) methods, widely used for photonic components packaging, for example.

LED Die Array 20

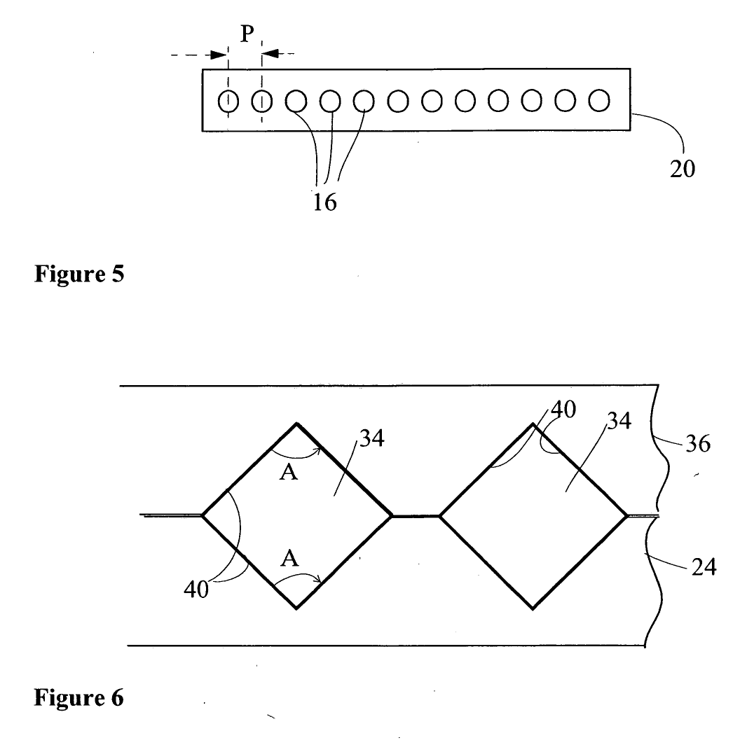

Referring to FIG. 5, there is shown a plan view of LED die array 20. Here, LED emitters 16 are spaced apart by a center-to-center pitch P. In a preferred embodiment, center-to-center pitch P is typically about 325 μm and LED emitters 16 have dimensions of about 260×315 μm and emit light at 450 nm (nominal). LED die arrays 20 providing components and layout of this type are available from various sources, including AXT Inc., Fremont, Calif., for example. Not shown in FIG. 5 are supporting wire trace connections made to individual LED emitters 16.

Uniformizer Array 26

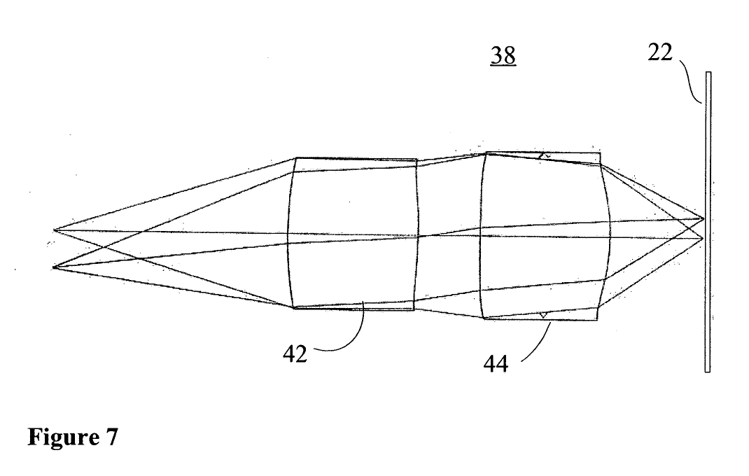

Referring back to FIG. 2, uniformizer array 26 is used both to direct light from each LED emitter 16 to its corresponding lens assembly 38 in lenslet array 28 and to smooth out the energy profile of LED emitters 16, with a single uniformizer 34 used for each LED emitter 16. Referring to FIG. 6, there is shown a cross-sectional view of a pair of uniformizers 34 according to one embodiment of the present invention. In this embodiment, uniformizer 34 is formed by applying a reflective coating to surfaces of sides 40 on both base 24 and cover 36. In this four-sided embodiment, angles A are preferably about 90 degrees, so that the overall cross-sectional shape of uniformizer 34 is square. Other cross-sectional shapes are possible, including hexagonal shapes, where cover 36 and base 24 would each have three sides 40, for example. With this arrangement, uniformizer 34 is essentially formed using a hollow cavity with reflective sides 40. The hollow cavity is formed when cover 36 and base 24 are joined, allowing straightforward fabrication and allowing the working length of uniformizer 34 to be optimized to meet performance requirements. As a general principle, the greater the length of uniformizer 34, the more uniform is the light output. A number of alternative types of uniformizer components could be employed, including optical fibers, for example. Any of a number of different types of reflective coating could be applied to sides 40 of uniformizer 34. Cover 36 and/or base 24 could alternately be formed from a reflective material, eliminating the need for any reflective coating.

Lenslet Array 28

Referring back to FIG. 2, lenslet array 28 directs the uniformized exposure light that is provided from uniformizers 34 onto photosensitive medium 22. In order to obtain the high numerical aperture needed for collecting sufficient exposure energy with small lenses, some type of aspheric surface is generally required for lens assembly 38. Manufacturability is a key concern when using miniature aspheric surfaces, such as those that would be required when using a single lens for lens assembly 38. Fabrication techniques such as gray scale etching technology, used by MEMS Optical, Inc., Huntsville, Ala., allow highly accurate microlens designs, but have constraints on allowable sag. In the preferred embodiment, as shown in FIG. 7, lens assembly 38 is a compound lens, with lens elements 42 and 44 having aspheric surfaces that allow microlens fabrication using gray scale etching technology or alternate techniques such as deposition using shadow-mask lithography, as described in U.S. Pat. No. 5,882,468. Each lens assembly 38 is fabricated from two precision-aligned microlens arrays in this embodiment, one array providing lens element 42, the other providing lens element 44. For realistic fabrication using gray scale etching, lens elements 42 and 44 should have sag of less than 40 microns. To provide increased light-gathering capability with constrained surface sag, lens elements 42 and 44 are fabricated from material having a high refractive index, zinc sulfide (n=2.46) in a preferred embodiment. In general, a refractive index above 2.0 would be desirable. The combination of surface and material characteristics of the preferred embodiment provides an optical design with lenslets having a maximum sag of 40 microns or less. In a preferred embodiment, magnification of 0.5× is provided by lens assembly 38.

Significantly, each of the three major components of printhead 10 is fabricated using precision techniques, using tools such as lithographic masking, that provide highly accurate component dimensions. Fabricated in this manner, LED die array 20, uniformizer array 26, and lenslet array 28 can then be mated together with precision during assembly of printhead 10. As a result, printhead 10 can be manufactured both inexpensively and to within very tight tolerances.

Apparatus Using Printhead 10

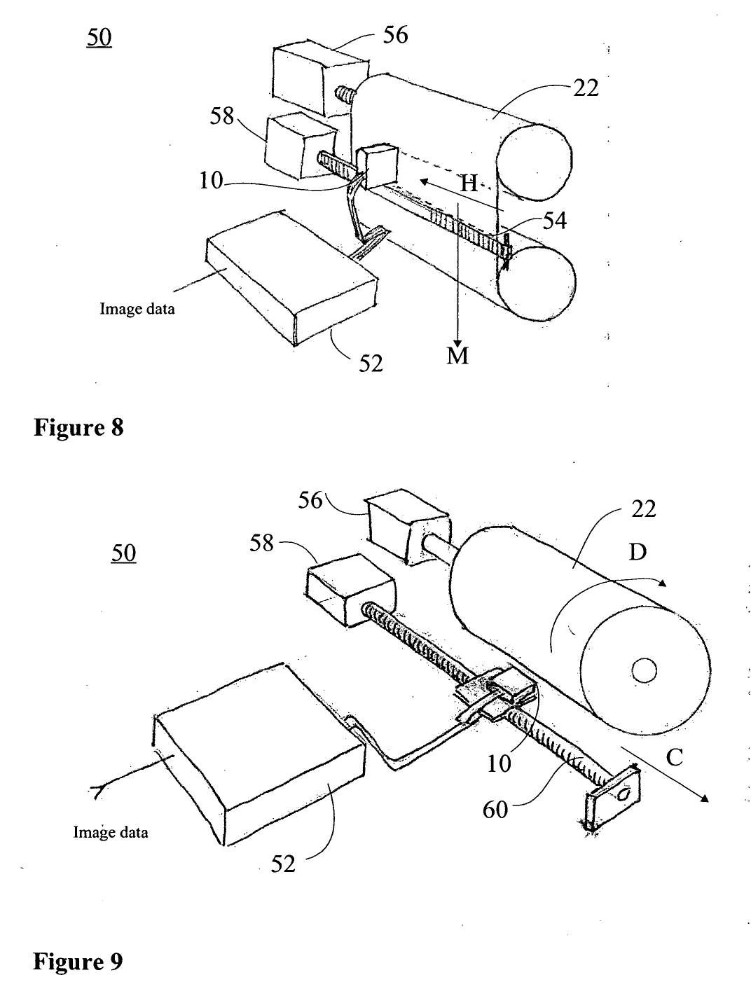

Referring to FIG. 8, there is shown one embodiment of a printing apparatus 50 using printhead 10 of the present invention. Image data is provided to a control logic processor 52 and then provided to printhead 10 for imaging onto photosensitive medium 22. A media transport 56, in communication with control logic processor 52, translates photosensitive medium 22 in a scan direction M relative to printhead 10. Media transport 56 may include one or more motors for driving one or more rotating drums, drive rollers, platens, or other mechanisms for moving photosensitive medium 22 in a controlled manner, as is well known in the printing arts. A head transport 58 is configured to move printhead 10 across photosensitive medium 22 in a scan direction H that is orthogonal to scan direction M of photosensitive medium 22. Head transport 58 may use any of a number of mechanisms for providing printhead 10 movement, such as using a movable belt 54, for example. Successive passes of printhead 10 across the surface of photosensitive medium 22 expose two-dimensional images onto photosensitive medium 22.

Referring to FIG. 9, there is shown an alternate embodiment of printing apparatus 50 using printhead 10 of the present invention. Here, media transport 56 moves photosensitive medium 22 past printhead 10 in the scan direction D, such as using a drum or other mechanism well known in the printing arts. Head transport 58 moves printhead 10 in scan direction C, orthogonal to direction D, using a lead screw 60 or other drive mechanism. With this arrangement, by moving printhead 10 continuously during imaging, printing apparatus 50 can expose a full, two-dimensional image onto photosensitive medium 22 as one continuous swath, imaged in a spiral pattern.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, while LED die arrays are described as illumination sources for printhead 10, other types of light source arrays could be used, with accompanying changes to system optics, as needed. Different types of LEDs and light emitting components are possible, including various types of Organic LEDs (OLEDs and PLEDs), and other components. All LED emitters 16 in LED die array 20 could have the same wavelength or an arrangement of LED emitters 16 having two or more wavelengths could be used, allowing scanning of printhead 10 to expose the same area of photosensitive medium 22 with a series of different wavelengths, to provide a full-color image, for example.

Thus, what is provided is an apparatus and method for printing onto a photosensitive medium using an array of LED light sources.

### Parts List

10 printhead
12 spatial energy profile curve
14 ideal energy profile curve
16 LED emitter
18 hot spot
20 LED die array
22 photosensitive medium
24 base
26 uniformizer array
28 lenslet array
30 signal interface
32 slot
34 uniformizer
36 cover
38 lens assembly
40 side
42 lens element
44 lens element
46 seat
50 printing apparatus
52 control logic processor
54 belt
56 media transport
58 head transport
60 lead screw

1. A multichannel printhead for forming an image onto a photosensitive medium by exposing pixels in a succession of exposures, the printhead comprising:
(a) an illumination array of light emitting diode (LED) light sources fitted into a housing at a first position;
(b) a lens array comprising a plurality of lenses fitted into said housing at a second position;
(c) a light-guiding array of uniformizer elements, arranged within a corresponding array of cavities formed within said housing and extended between said first position and said second position; and
wherein, for each pixel exposed on the photosensitive medium:
a single said LED light source in said illumination array provides light into a single corresponding said uniformizer element in said light-guiding array which directs light to a corresponding said lens of said lens array.

2. A multichannel printhead according to claim 1 wherein said housing is formed from a silicon substrate.

3. A multichannel printhead according to claim 1 wherein said housing is formed from a base section and a cover section.

4. A multichannel printhead according to claim 1 wherein said uniformizer elements comprise a reflective surface.

5. A multichannel printhead according to claim 1 wherein at least one uniformizer element comprises an optical fiber.

6. A multichannel printhead according to claim 1 wherein said array of cavities is formed by aligning a first set of grooves in said base section with a corresponding second set of grooves in said cover section.

7. A multichannel printhead according to claim 1 wherein at least one said lens in said lens array is a compound lens.

8. A multichannel printhead according to claim 7 wherein said compound lens comprises a plurality of aspheric surfaces.

9. A multichannel printhead according to claim 8 wherein the sag of any of said plurality of aspheric surfaces is less than about 40 microns.

10. A multichannel printhead according to claim 7 wherein said compound lens comprises a material having a refractive index greater than 2.0.

11. A multichannel printhead according to claim 1 wherein said lens array provides non-unity magnification of said illumination array of LED light sources.

12. A multichannel printhead according to claim 1 wherein said illumination array is fabricated on a single substrate.

13. A multichannel printhead according to claim 1 wherein said LED light sources each emit substantially the same wavelength.

14. A multichannel printhead according to claim 1 wherein different said LED light sources in said illumination array emit different wavelengths.

15. A multichannel printhead according to claim 1 wherein said cavities are substantially parallel.

16. A printing apparatus for forming an image onto a photosensitive medium, comprising:
(a) a multichannel printhead for forming an image onto a photosensitive medium by exposing pixels in a succession of exposures, the printhead comprising:
(i) an illumination array of LED light sources fitted into a housing at a first position;
(ii) a lens array comprising a plurality of lenses fitted into said housing at a second position; and
(iii) a light-guiding array of uniformizer elements, arranged within a corresponding array of cavities formed within said housing and extended between said first position and said second position;
wherein, for each pixel exposed on the photosensitive medium:
a single said LED light source in said illumination array provides light into a single corresponding said uniformizer element in said light-guiding array which directs light to a corresponding said lens of said lens array;
(b) a media transport for providing spatial translation of the photosensitive medium relative to said printhead; and
(c) a printhead transport for scanning said printhead across a surface of the photosensitive medium, forming an exposed image thereby.

17. A printing apparatus according to claim 16 wherein said media transport comprises a rotating drum.

18. A printing apparatus according to claim 16 wherein said printhead transport comprises a drive belt.

19. A printing apparatus according to claim 16 wherein said printhead transport comprises a lead screw.

20. A printing apparatus according to claim 16 wherein said media transport comprises a drive roller.

21. A printing apparatus according to claim 16 wherein said housing is formed from a silicon substrate.

22. A printing apparatus according to claim 16 wherein said housing comprises a base section and a cover section.

23. A printing apparatus according to claim 16 wherein said uniformizer elements comprise a reflective surface.

24. A printing apparatus according to claim 16 wherein at least one uniformizer element comprises an optical fiber.

25. A printing apparatus according to claim 16 wherein said cavities are formed by aligning a first set of grooves in said base section with a second set of grooves in said cover section.

26. A printing apparatus according to claim 16 wherein at least one said lens in said lens array is a compound lens.

27. A printing apparatus according to claim 26 wherein said compound lens comprises a plurality of aspheric surfaces.

28. A printing apparatus according to claim 27 wherein the sag of any of said plurality of aspheric surfaces is less than about 40 microns.

29. A printing apparatus according to claim 27 wherein said compound lens comprises a material having a refractive index greater than 2.0.

30. A printing apparatus according to claim 16 wherein said lens array provides non-unity magnification of said illumination array of LED light sources.

31. A printing apparatus according to claim 16 wherein said illumination array is fabricated on a single substrate.

32. A printing apparatus according to claim 16 wherein said LED light sources each emit substantially the same wavelength.

33. A printing apparatus according to claim 16 wherein different said LED light sources in said illumination array emit different wavelengths.

34. A printing apparatus according to claim 16 wherein said cavities are substantially parallel.

35. A multichannel printhead for forming an image onto a photosensitive medium by exposing pixels in a succession of exposures, wherein each channel of the multichannel printhead comprises:
(a) a light source fitted within a housing at a first position;
(b) a lens fitted into said housing at a second position for directing exposure light onto the photosensitive medium;
(c) a uniformizer element comprising a reflective cavity formed within said housing and extended between said first position and said second position; and
wherein, for exposing each pixel, said light source provides said exposure light to said uniformizer element, which guides said exposure light to said lens.

36. A multichannel printhead according to claim 36 wherein said light source is an LED.

37. A method for forming an image onto a photosensitive medium by exposing pixels in a succession of exposures, the method comprising:
(a) fitting an illumination array of LED light sources into a housing at a first position;
(b) seating a lens array against said housing at a second position;
(c) extending a light-guiding array of uniformizer elements, arranged within a corresponding array of cavities formed within said housing, between said first position and said second position; and
wherein, for each pixel exposed on the photosensitive medium:
a single said LED light source in said illumination array provides light into a single corresponding said uniformizer element in said light-guiding array which directs light to a single corresponding said lens of said lens array.

38. A method for forming an image according to claim 37 wherein the step of extending a light-guiding array of uniformizer elements comprises the step of providing at least one optical fiber.

39. A method for forming an image according to claim 37 wherein the step of extending a light-guiding array of uniformizer elements comprises:
(a) forming a series of grooves in said housing; and
(b) providing a reflective surface within at least one surface of at least one of said parallel grooves.

40. A method of manufacture of a printhead for forming an image onto a photosensitive medium by exposing pixels in a succession of exposures, the method comprising:
(a) forming an illumination array of LED light sources on a single substrate;
(b) forming a lens array comprising a plurality of lenses;
(c) forming a light guiding array of uniformizer elements, arranged within a corresponding array of cavities formed within a housing;
(d) forming a slot within said housing, said slot perpendicular to said light guiding array and at one end of said light guiding array, and aligning, in said slot, said illumination array with said light guiding array, whereby each said LED light source is aligned with one of said cavities; and
(e) forming a seat at the output side of said housing, said seat parallel to said slot and at the opposite end of said light guiding array from said slot, and aligning said lens array in said seat, whereby each lens in said plurality of lenses is aligned with one of said cavities.

41. A method of manufacture according to claim 40 wherein the step of forming a light guiding array further comprises the step of forming a first array of grooves in a base and a second array of matching grooves in a cover and coupling said cover to said base, forming said cavities thereby.

42. A method of manufacture according to claim 40 wherein the step of forming a lens array comprises the step of aligning a first lenslet array with a second lenslet array.

43. A method of manufacture according to claim 40 wherein the step of forming a light guiding array comprises the step of applying a reflective coating.

44. A method of manufacture according to claim 40 wherein the step of forming a lens array comprises the step of using gray scale etching.

45. A multichannel printhead for forming an image onto a photosensitive medium the printhead comprising:
(a) an illumination array of light sources fitted into a housing at a first position;
(b) a lens array comprising a plurality of lenses fitted into said housing at a second position;
(c) an array of uniformizer elements, arranged within a corresponding array of cavities formed within said housing and extended between said first position and said second position; and
wherein, for each pixel exposed on the photosensitive medium:
a single said light source in said illumination array provides light into a single corresponding said uniformizer element in said array of uniformizing elements which directs light to a corresponding said lens of said lens array.

46. A multichannel printhead according to claim 45 wherein at least one of said light sources is a light emitting diode (LED).

47. A multichannel printhead according to claim 45 wherein at least one of said light sources is an organic light emitting diode (OLED).

48. A multichannel printhead according to claim 45 wherein said uniformizer elements comprise a reflective surface in said array of cavities.

49. A multichannel printhead according to claim 45 wherein at least one uniformizer element comprises an optical fiber.

50. A multichannel printhead for forming an image onto a photosensitive medium by exposing pixels in a succession of exposures, the printhead comprising:
(a) an illumination array of light emitting diode (LED) light sources fitted into a housing at a first position;
(b) a lens array comprising a plurality of lenses fitted into said housing at a second position;
(c) a light-guiding array of uniformizer elements, arranged within a corresponding array of cavities formed within said housing and extending between said first position and said second position;
wherein, for each pixel exposed on the photosensitive medium:
a single said LED light source in said illumination array provides light to a single corresponding uniformizer element in said light-guiding array which directs light to a corresponding lens of said lens array;
wherein said housing is formed from a base section and a cover section;
wherein said uniformizer elements comprise a reflective surface on interval surfaces of at least one of said cavities; and
wherein at least one of said lens in said lens array is a compound lens.
